(19) United States
(12) Patent Application Publication
(10) Pub. No.: US 2007/0027728 A1
(43) Pub. Date: Feb. 1, 2007

(54) System and method for protecting a security

(76) Inventors: Steven S. Schuver, St. Louis, MO (US); David D. Schuver, St. Louis, MO (US); Thomas L. Bakos, Ridgway, CO (US)

Correspondence Address: David H. Chervitz;Riezman Berger, P.C., 7th Floor, 7700 Bonhomme Avenue, St. Louis, MO, 63105, US

(21) Appl. No.: 11/542,588

(22) Filed: Oct. 4, 2006

Related U.S. Application Data
(63) Continuation-in-part of application No. 10/875,704, filed on Jun. 24, 2004.

(51) Int. Cl. G06Q 40/00

(52) U.S. Cl. 705/4; 705/35

(57) ABSTRACT

A method for protecting a security comprises the steps of obtaining a security and purchasing a financial instrument for protecting against a change in the value of the security. A system for protecting a security is also disclosed in which the system comprises a computer system for entering information related to the security and a server system for receiving the entered information and for calculating a price for a financial instrument for protecting a security and the server system for transmitting the price to the computer system. A method and system for protecting a portfolio of securities is also disclosed.

### CROSS REFERENCE TO RELATED APPLICATIONS

This application is a continuation-in-part of U.S. patent application Ser. No. 10/875,704, which was filed on Jun. 24, 2004.

### BACKGROUND OF THE INVENTION

This invention relates to protecting a security and more particularly to a system and method for protecting the value of a security.

Investors may invest in numerous types of securities in an attempt to achieve short-term or long-term appreciation in the price or value of the security. In particular, an investor among other things may invest in stocks, mutual funds, options, commodities, futures, derivatives, stock index futures, certificates of deposit, exchange traded funds, hedge funds, or bonds by purchasing such securities. Initially, such securities or assets have a purchase price or basis. The investor attempts to maximize the return on investment by selecting assets or securities that either increase in value or do not allow their principal to erode or decline in value. Due to the unpredictable and volatile nature of securities, investors may find it advantageous to protect the principal by preventing any loss that may occur in the purchase price or basis of the security. One way to try to protect against such an occurrence is to purchase an option contract. For example, an option contract gives an investor the right, but not the obligation, to purchase or sell a certain number of shares of stocks at a specific price at a specific future time. An investor pays a price for the right to purchase or sell the certain number of shares at the specific price at a future date. If the investor does not purchase or sell the stock, the investor is out the money paid to purchase the option contract. However, such option contracts are complex, difficult to understand, date limited, risky, and expensive. Further, such option contracts are only available for a limited number of stocks and cannot be purchased for other securities such as mutual funds or bonds or a portfolio of securities. Accordingly and unfortunately, options contracts do not offer the protection sought or needed.

Some investors have bought government bonds, corporate bonds, municipal bonds, or debt obligations that are backed or guaranteed by a government or a company in an attempt to protect against a default in the bond. However, such bonds pay an interest rate that is below the market interest rate making it a less attractive security. Additionally, some government-backed bonds require a large amount of money to purchase these bonds. Thus, the purchases of such bonds are only practical for large institutions, banks, or companies. Again, such bonds do not allow an individual investor the opportunity to hedge their risks against a change in market value.

Therefore, it would be desirable to protect an asset or a security from declining in value. It is also desirable to protect an individual's portfolio that may be comprised of combinations of various securities. It would also be advantageous to offer a product, such as a financial product, a contract, or an instrument, for protecting against a change in the value of a security or a portfolio of securities.

The present invention is designed to obviate and overcome many of the disadvantages and shortcomings associated with attempting to protect the value of a security. In particular, the present invention is a system and method for hedging or protecting the value a security. With use of the present system and method, an investor is able to purchase a financial instrument, product, or contract that protects against a decline in the value of an owned security. The investor is able to pay a price, premium, or a charge for the financial instrument that will protect the value of the owned security. Moreover, the system and method of the present invention can be employed to protect against a decrease or an increase in the price of a security. Once the financial instrument is purchased, an owner of a security is protected from any loss the owner may suffer as a result of a change in the market value of the security during the coverage period of the financial instrument.

### SUMMARY OF THE INVENTION

In one form of the present invention, a method for protecting a security comprises the steps of obtaining a security and purchasing a financial product for protecting against a change in the value of the security.

In another form of the present invention, a system for protecting a security comprises a computer system for entering information related to a security and a server system for receiving the entered information and for calculating a price for a financial instrument for protecting a security and the server system for transmitting the price to the computer system.

In another form of the present invention, a method of protecting a portfolio of securities comprises the steps of obtaining a portfolio of securities and purchasing a financial instrument for protecting against a change in value of the portfolio.

In light of the foregoing comments, it will be recognized that a principal object of the present invention is to provide a system and method for protecting against a loss or decline in the price or the value of a security.

A further object of the present invention is to provide a system and method for providing a financial product that may be purchased by an investor to protect an asset or a security.

Another object of the present invention is to provide a system and method for protecting against an increase in a price of a security.

A still further object of the present invention is to provide a system and method for protecting or hedging the value of a security that is easy to use and understand.

Another object of the present invention is to provide a system and method for protecting the value of a portfolio of securities.

A further object of the present invention is to provide a system and method for determining a price for the financial product for protecting an owner's position in a security or an asset.

These and other objects and advantages of the present invention will become apparent after considering the following detailed specification in conjunction with the accompanying drawings, wherein:

### BRIEF DESCRIPTION OF THE DRAWINGS

FIG. 1 is a flow chart diagram illustrating a preferred operation of the method for protecting a security according to the present invention;

FIG. 2 is a flow chart diagram illustrating a method for selecting various requirements for a financial instrument for protecting a security according to the present invention;

FIG. 3 is a flow chart diagram illustrating a method for calculating a price to be charged for purchasing a financial instrument for protecting a security according to the present invention;

FIG. 4 is a flow chart diagram illustrating a method for purchasing a financial instrument for protecting a security according to the present invention;

FIG. 5 is a table illustrating a number of financial instruments or products that may be purchased to protect a security;

FIG. 6 is a block diagram of a system for protecting a security constructed according to the present invention;

FIG. 7 is an illustration of a screen which may be presented during use of the system for protecting a security to enter product parameters;

FIG. 8 is an illustration of a screen that may be presented during use of the system for protecting a security to accept a price to be charged for a financial instrument;

FIG. 9 is an illustration of a screen that may be presented during use of the system for protecting a security to enter product parameters for a portfolio of securities;

FIG. 10 is a flow chart diagram illustrating a method for determining or calculating a price to be charged for a financial instrument for protecting a security;

FIG. 11 is a flow chart diagram illustrating a method for determining or calculating a price to be charged for a financial instrument for protecting a portfolio of securities;

FIG. 12 is an illustration of a screen that may be presented during use of the system for protecting a security to select one or more securities to be protected; and

FIG. 13 is an illustration of a screen that may be presented during use of the system for protecting a security to select a price for a financial instrument.

### DETAILED DESCRIPTION OF THE PREFERRED EMBODIMENTS

Referring now to the drawings, wherein like numbers refer to like items, number 10 identifies a preferred method for protecting a security according to the present invention. With reference now to FIG. 1, the method 10 is shown to comprise a first step 12 in which a user obtains, acquires, or purchases a security. Examples of securities that may be obtained, acquired, or purchased are stocks, bonds, mutual funds, options, commodities, futures, derivatives, stock index futures, certificates of deposit, hedge funds, and exchange traded funds. A second step 14 of the method 10 comprises a user purchasing a financial product, instrument, or contract to protect against a change in the value of the security obtained in the step 12. Proof of ownership or interest in the security may be required in order to purchase or issue the financial product. In this manner, if the value or the price of the security decreases over time, the user will be protected against any decrease in the value or price of the security. In particular, if at the end of the term of the financial product the price or market value of the security is below the protected price or value, the financial product will pay the difference between the protected price of the security and the value or the price of the security on the day that the financial product terminates. It is possible and contemplated that a user may purchase the financial product at any time the user owns or has an interest in the security. In other words, it is not necessary that the user purchase the financial product when a security is initially purchased or obtained. For example, if the user purchases a share of stock on January 1 for $10 and the price of the stock increases to $15 by July 1 then the user may purchase the financial product on July 1 to protect against a decrease in the price of the stock as of July 1. In essence, the user may lock in the price paid for obtaining the security plus the gain in the price of the stock. It is also possible that the user may purchase the financial product when the security is initially purchased or obtained and later on purchase another financial product if the security increases in price or value. Further, it is possible that the financial product may protect against a gain in the price or value of a security in the case of a short sale. A security may be obtained in several ways as by gift, inheritance, purchase, settlement, wager, theft, discovery or treasure, contract, or by agreement.

In particular, the financial product may be a financial contract designed to protect the price of the underlying security. As was previously indicated, once a security is obtained a user may purchase the financial product to protect the value of the security. For example, if a share of stock is purchased by an investor for $10 per share then the investor can purchase the financial product to protect against any decline in the stock. The $10 per share may be the protected price and if the price of the stock declines below the protected price then the financial product will pay the investor the amount that the stock has declined. By way of example, if the stock price is now $7 per share, the financial product will pay the investor $3 per share. As can be appreciated, if the stock price were to increase to $12 per share then the financial product would not have to pay anything.

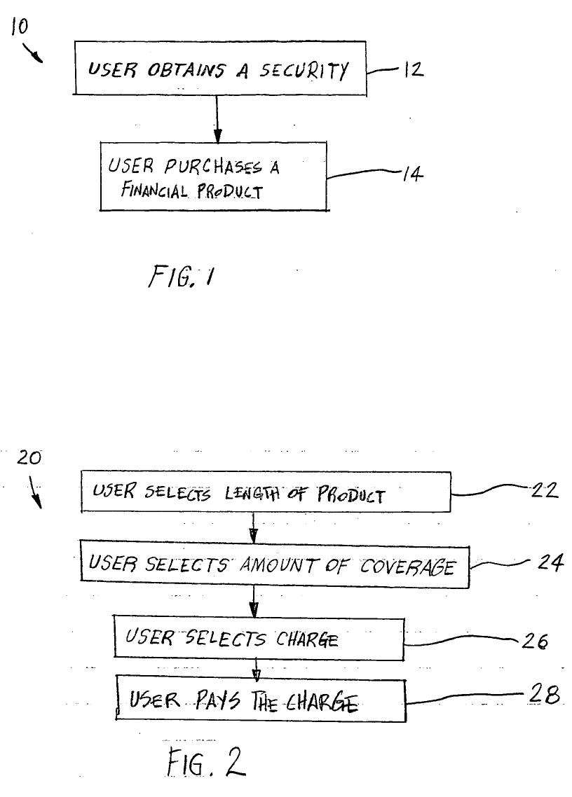

FIG. 2 shows a process 20 for the user to use in selecting certain requirements for purchasing a financial product for protecting a security. For purposes of example only, the user may own 200 shares of a publicly traded corporation with the present share price being $50. The user is interested in protecting against a decline in value of the owned stock. In order to do this the user wants to purchase a financial product as herein described. In a first step 22, the user selects the length or term that the security will need to be protected. For example, the user may want to protect against a loss in the purchase price or the value of a security for a term of one year. The user may need to sell the security within a year to pay for retirement and the user wants to protect against a decline in value of the security. Once the length is selected, the user selects the amount of coverage as shown in a second step 24. The user may decide that only protecting a portion of the value or the price of the security is required or desired. For example, the user, as described above, may only want to protect half of the user's position in the stock or protect the value of 100 shares of the stock. After selecting the amount of coverage, the user will be able to calculate or review the charge or price being requested by an issuing entity to protect the security. In this step, step 26, the user is required to determine whether the user will pay the quoted charge. For example, the issuing entity may charge $2 per share to protect against a decline in value of the stock for a period of one year. If this is acceptable to the user, then the user pays the charge as is represented in a next step, step 28. If at the end of the term of coverage the price of the stock declines to $47 per share the issuing entity will pay the user $3 per share. On the other hand, if at the end of the term of coverage the price of the stock increases to $52 per share, the issuing entity is not obligated to pay anything to the user.

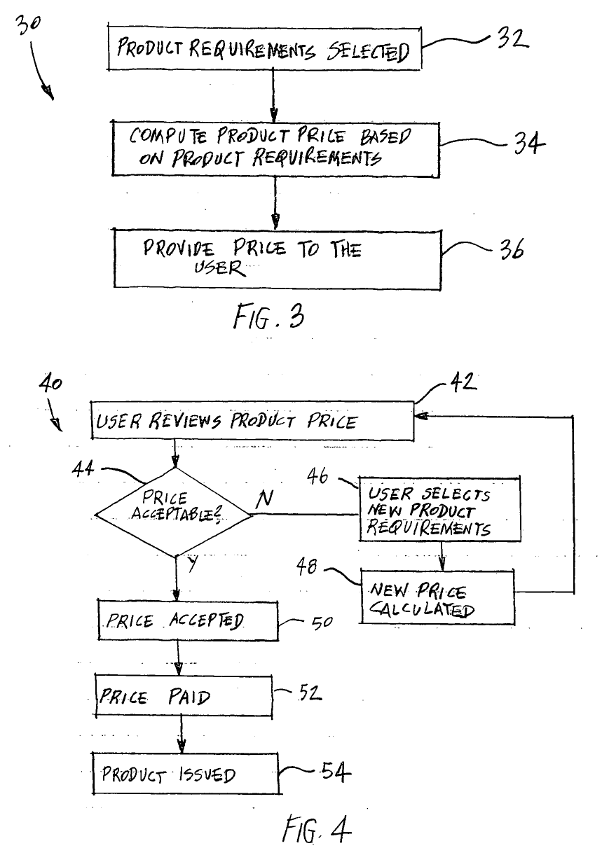

With reference now to FIG. 3, a flowchart illustrates a process 30 for calculating a price to be charged for the financial product or instrument. First, in a step 32, the user selects product requirements that may include identification of the security, product term, and product amount. Once the product requirements are selected a price to be charged for purchase of the product is calculated based on the selected or determined product requirements. This is accomplished in a step 34. Some parameters used to calculate or compute the product price may include whether the security is volatile. If the security is volatile then this may require a higher price that is charged. Also, a coverage period of a long term may impact the price of the product. Once calculated, the product price is provided to the user in a step 36. The price or prices to be charged for the product may be in the form of a table as will be explained further herein.

FIG. 4 is a flowchart that illustrates a process 40 for purchasing a financial product for protecting a security. In a first step 42 the user reviews or evaluates the price to be charged that has been calculated or determined based on various product requirements. Once the evaluation is completed, the user determines, in a step 44, whether the amount is acceptable. If the price is not acceptable then the user selects or determines new product requirements in a step 46. For example, in order to reduce the price or the amount to be charged, the user may select a shorter term for the financial product. In a next step 48, a new price is calculated or determined based upon the new product requirements decided in the step 46. The new price is provided to the user in the step 42 where the user again reviews the price.

If in the step 44 the user determines that the price quoted is acceptable, a next step 50 is encountered where the product is accepted. Further, in a step 52, the price is paid by the user. Finally, in a step 54, the financial product or instrument is issued to the user. It is also possible that the order of the steps 52 and 54 may be reversed. In particular, the financial product may be issued and provided to the user with a bill or invoice to pay the charge or the price for the financial product.

For purposes of example only, if the price of the stock either during the term of the financial product or at the end of the term of the financial product is below the protected price then the user may make a claim against the financial product for payment of the difference between the protected amount and the price of the stock. It is also possible and contemplated that at the expiration of the term of the financial product the user may purchase another financial instrument to protect the price of the security. For example, if at the end of the term of the financial product the price of the stock is the protected price or greater than the protected price then no claim may be made and the user may purchase another financial product to protect against a decline or a reduction in the price of the stock. In this manner, the user may purchase a financial product in serial fashion to protect the value of the security for the entire term that the user owns the security.

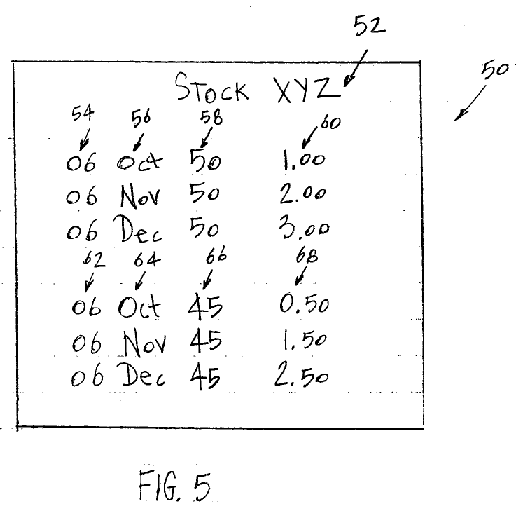

Referring now to FIG. 5, there is depicted a table 50 of a listing of prices that may be charged for purchasing a financial product to protect a security. By way of example only, the table 50 is used to determine prices for stock issued by a hypothetical company XYZ. The table 50 has a heading 52 that indicates the security that may be protected. As has been previously discussed, the security to be protected may include such securities as stocks, bonds, mutual funds, options, commodities, futures, derivatives, stock index futures, certificates of deposit, and exchange traded funds. The heading 52 may include other information such as the current price for a share of XYZ stock. The table 50 also includes a column 54 that identifies the year, in this example 2006, a second column 56 that indicates the month that the financial product will terminate or expire, a third column 58 that identifies the protected price for the security, and a fourth column 60 that shows the price to be charged for the financial product. In this particular example, if the user wants to select a protected price of $50 per share for a thirty day term then the user will be required to pay $1.00 per share to purchase this financial product.

The table 50 may include another set of columns 62, 64, 66, and 68 which relate to another protected price, in this example a protected price of $45 per share. In particular, the column 62 indicates the year, the column 64 identifies the month, the column 66 indicates the protected price, and the column 68 identifies what the price or charge will have to be paid in order to protect the security. As can be appreciated, other protected prices may be included in the table 50.

The protected price of $45 per share versus $50 per share may be selected due to some different situations. For example, the user may have obtained the share of XYZ company at a purchase price of $40 per share. Although the current trading price of the share may be $55, the user may only want to protect against a decline in value below $45 per share. In this manner, the user will pay less for the financial product due to the difference being charged for the financial product at the protected price of $50 per share which is $1.00 per share and the price of the financial product at the protected price of $45 per share which is $0.50 per share. In this manner the user can select or adjust the desired amount of coverage.

By way of further example, if the user purchased the financial product having a termination date of the last day for October 2006 with a protected price of $50 and the actual price of the XYZ stock is at $47 on the termination date then the financial instrument will pay out a benefit of $3 per share. The $3 is the difference between the protected price and the price on the stock on the date of termination of the financial instrument.

As can be appreciated from a review of the table 50, the financial product can only be purchased and may not be sold or resold. The product, once purchased, does not increase or decrease in value during the term of the product. If the underlying security is sold during the term of the financial product then the financial product will expire. Other contractual terms may be a part of the financial product as may be required by the issuing entity of the financial product. For example, in the event of a stock split, spin off, or taking a public company private the financial product may include terms as to how these situations may impact the performance of the financial product.

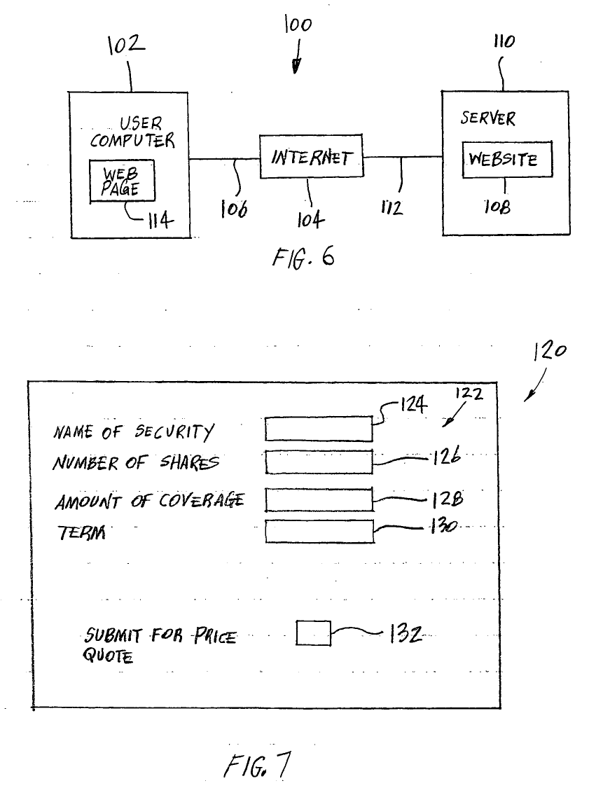

A system for protecting a security 100 is illustrated in FIG. 6. The system 100 is shown comprising a user computer system 102 that is capable of being connected to the Internet 104 by a communications connection 106 such as a telephone line, cable, ISDN lines, fiber optic lines, wireless connections, satellites, or other suitable means of connection. Through use of the connection 106 to the Internet 104, the computer 102 is capable of accessing a website 108 on a computer system or a server 110 over a connection 112. The website 108 may be a website of a brokerage, a bank, an insurance company, or any other entity that a user may purchase a security. As described for the connection 106, the connection 112 may include a telephone line, cable, ISDN lines, fiber optic lines, wireless connections, satellites, or other means of connection. The server 110 is capable of transmitting to the user computer 102 one or more web pages 114 for viewing by a user of the user computer 102.

The user computer 102 is allowed access to the server 110 through use of a commonly available web browser or similar software package or application. The server 110 is capable of hosting the website 108 which presents various screens or web pages 114 to the user computer 102. A user operating the user computer 102 is able to interact with the website 108 being hosted by the server 110. In particular, a user may be presented with various screens or web pages 114 with such web pages 114 presenting information concerning the purchasing of a security and the purchasing of a financial instrument for protecting a security. The web pages 114 may also be shown the table 50 for a user to determine which financial product should be purchased. Further, the web pages 114 may have other information such as selecting a term, an amount of coverage, and entering of information concerning a security already owned.

The user may be presented with a web page or screen 120 as illustrated in FIG. 7. As shown, information or parameters 122 for obtaining a price quote for a financial product for protecting a security are presented for selection or entry by the user. The user is requested to enter information concerning the name or symbol of the security to be protected in a box 124 and the number of shares that are owned in a box 126. The amount of coverage that is desired which may be either the number of shares owned, or a portion of the number of shares owned, or a dollar amount is entered in a box 128. For example, the user may determine that only half of the value of the security to be protected needs to be covered and this amount is entered in the box 128. The term of coverage for the financial product is selected and entered in a box 130. The user can determine the length of the term of the financial product. Once the user has entered the parameters 122, a button 132 may be selected to transmit the parameters 122 to the server 110 in order to determine or calculate a price or a charge for the financial product for protecting the security presented in the box 124. Once the server 110 receives the parameters 122, a price or a charge is calculated. The price or the amount is then sent to the user computer 102 to be displayed as a screen or a web page 114.

FIG. 8 depicts a web page 150 that may be presented on a display associated with the user computer 102. The web page 150 has a box 152 in which the price or charge for the financial instrument for protecting a security is displayed for review by the user. The price or charge may be displayed in a total amount or by a per share amount. The user may accept the price by selecting a button 154, reject the price by selecting a button 156, or recalculate the price by selecting a button 158. If the button 154 is selected, the user may be requested to indicate a payment method for the price. If the price is to be paid by a credit card then a box 160 is selected and the user is taken to a new web page to enter further information concerning the credit card. If the price is to be paid by a bank account then a box 162 is selected and a new web page is presented for entry of bank account information. Also, if the price is to be paid out of the user's brokerage account then a box 164 is selected and a new web page is presented for entry of brokerage account information. Other methods of payment, such as cash, check, invoice, or being billed are contemplated and possible and such methods may be incorporated into the web page 150. If the user decides that the price is too high and protecting the security is to be foregone then the box 156 is selected and the user may be taken to a home page of the server 110. On the other hand, if the user selects the box 158, the user will be presented the web page 120 again to enter the parameters 122 in an attempt to recalculate the price for the financial instrument. For example, the price presented in the box 152 may be more than the user wants to pay. In order to reduce the price the user selects the box 158 and the web page 120 is presented for entry of other amounts. The user, in an attempt to lower the price, may enter into the box 128 a lower amount of coverage. In this manner, the price is recalculated and the recalculated price may be low enough that the user selects the accept box 154. In this manner, the user may go back and forth until an acceptable price of the financial instrument is calculated or obtained. As can be appreciated, several other web pages may be presented to the user. By way of example, web pages may be presented that include the conditions and terms of the financial instrument and payment confirmation.

Although not shown, the computer system 102 may include peripheral devices such as a keyboard, a speaker, a display, a printer, a modem, a network card, and any other suitable device. The computer system 102 may be a personal computer having a microprocessor, memory, a hard drive having stored thereon an operating system and other software, and input devices such as a mouse, a keyboard, a CD-ROM drive, or a floppy disk drive. The computer system 102 may also be a PDA type device, a cell phone, or other hand held type computer device that allows for receiving and transmitting information or data. Further, the server 110 may take on various known forms for a server including a personal computer, a computer system, or a network. Also, although the Internet 104 is disclosed, it is also possible that the system 100 be located on a LAN or other closed network system. For example, a bank or a brokerage house may have an internal system that the user may use to obtain a price quote for the financial instrument.

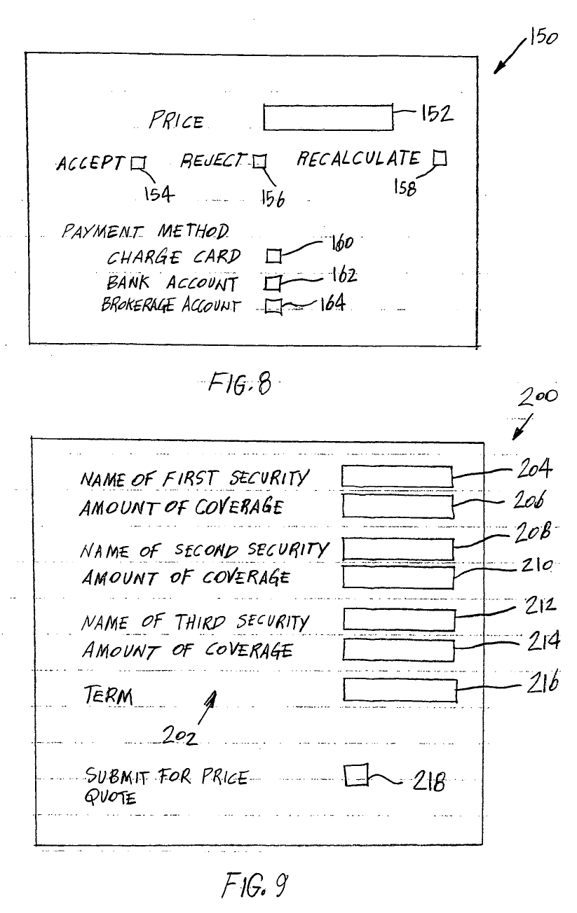

It is also possible to protect a number of different securities or a portfolio through use of the present invention. With reference now to FIG. 9, a web page 200 is illustrated that provides for entry of more than one security for calculating one price quote to protect a number of securities or a portfolio. The web page 200 requests the user to enter various parameters 202. In a box 204, the name of the first security is entered. Below the box 204 is a box 206 in which the amount of coverage for the first security is entered. Once the information for the first security has been entered, information relating to a second security and a third security may be entered in boxes 208, 210, 212, and 214. After the security information has been entered the term of protection is entered into in a box 216. After all of the parameters 202 have been entered a button 218 may be selected to calculate a price for the financial instrument. The information relating to the parameters 202 is transmitted to the server 110 in order to determine or calculate a price for protecting the securities presented in the boxes 204, 208, and 212. It is also possible that there are more boxes for entering other securities or other web pages similar to the web page 200 may be provided until all of the securities or the entire portfolio has been entered. For example, there may be a box for entering information such as the number of shares owned. It is also contemplated that the term may be individually selected for each security. Further, a listing of individual prices per security may be provided in which a user may select which security will be protected. It may be that the price for one of the securities to be protected is determined to be too high and the user may select not to protect the particular security.

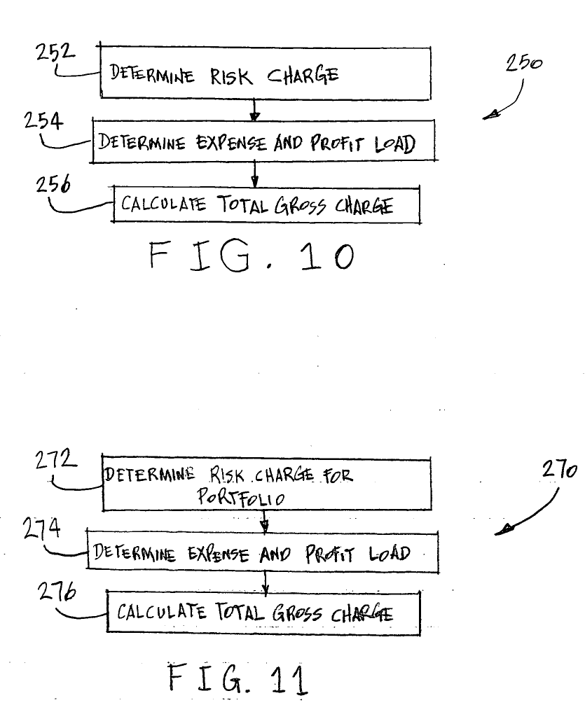

The following discussion pertains to various methods and systems for determining or calculating a price to be charged for a financial instrument. With particular reference now to FIG. 10, a flow chart diagram of a method for determining or calculating a price to be charged for a financial instrument or product 250 is shown. In a first step 252, a risk charge or a net single charge is determined. The risk charge may be based on such factors as the protected amount, the term of coverage, and the current price of the security to be protected. Once the risk charge is determined an expense and profit load is then determined in a step 254. In a next step 256, the risk charge and the expense and profit load are added together to arrive at a total gross charge. The total gross charge is the price or amount an investor will pay to protect a security. The total gross charge may be presented, by way of example, via the web page 150 in the box 152 to be displayed for review by the user or the investor, as is shown in FIG. 8.

As indicated above, the pricing methodology involves determining a risk charge or a net single charge and an expense and profit load added to the net single charge. The calculation for determining a risk charge may be based on the assumption that the underlying risk in a financial product for protecting a security which protects against a decrease in the value of the protected security during a term of coverage is equivalent to the price of a put option on that security with a strike price equal to the protected amount and a term of coverage equal to the time to expiry for the option. The basic Black-Scholes options pricing formula can be used to price European style options with no provision for dividends. Generally, dividends have only a small impact on the price of an option and in the calculations performed herein dividends are ignored. However, it is possible and contemplated to include dividends when performing the calculation to determine a price to be charged for purchasing the financial product. Further, it is also contemplated to employ other options pricing formulas or algorithms to determine a risk charge such as Binomial Pricing, Flexible Binomial Pricing, Finite Difference, and Analytic Approximation. Although the following examples show use of Black-Scholes options pricing formula for put options, it is to be understood that in the event of a customer wanting to protect a security from an increase in value, in the case of shorting a security, then the use of Black-Scholes options pricing formula for a call option may be employed.

The expense and profit load is added to the net single charge covering the risk to obtain a total gross single charge or price to be charged for protecting for a security. In order to achieve a competitive gross single charge for the financial instrument the expense and profit load needs to be reasonably related to the commissions and other expenses an investor might incur in order to put a similar hedging program into effect using exchange traded options.

The Black-Scholes formula for pricing an European put option is as follows: p=Ke^{-rt}N(−d_{2)-SN(-d}₁) where K=the protected amount, r=the risk free interest rate, t=the term of coverage, S=the current stock price, d₁=[1n(S/K)+(r+σ²/2)t]/σ√t, and d₂=d₁−σ√t. The function N(x) denotes the standard normal cumulative distribution function. Also, σ means volatility that is the annual standard deviation of the stock price and is expressed as a percentage or as a decimal number. For example, a volatility of 25% would be applied as 0.25 in the formula.

With respect to determining a price to be charged for protecting a security, the following pricing data may be applied in the above formula to effectively calculate a net single charge or risk charge. The pricing data taken from the application would include the following. The stock or security name and symbol would be provided by the investor or obtained from the investor's brokerage house records. The number of shares owned or on which protection or coverage is desired would be provided by the investor or looked up on the investor's brokerage house records. The protected amount (K) would be the current value of the shares the investor wishes to protect. However, it is possible and contemplated that the protected amount could be different than the current value of the shares. For example, the investor may be interested in protecting half the value of the shares. The total protected amount would reflect the number of shares owned. The term of coverage (t) would be selected by the investor.

Other pricing data could come from readily available information or sources. The current stock price (S) would be determined from the investor's brokerage house records or determined by a lookup on one of the many stock price quote services. The protected amount is the equivalent of the strike price in the Black-Scholes option pricing formula.

The r or risk free rate of return can be based on the Federal Funds rate or U.S. Government securities for a term similar to the term of coverage. As of Apr. 15, 2005, by way of example, the Federal Funds rate was 2.78%. For one year government securities the rate on Apr. 13, 2005, was 3.32%. Interest would have only a minor impact on the pricing of a put option of short duration and, in any event, low interest rates tend to increase the price of a put. Therefore, in the interest rate environment noted for Apr. 13, 2005, a rounded risk free rate of return of, say, 2.75% might be used in pricing since it is at the low end of the range used. However, another interest rate assumption near the observed rates might also be used and chosen taking into account interest rate volatility such that it could be used in pricing calculations for a reasonable period of time without daily changes.

Volatility can be measured historically. However, the volatility used in the pricing calculation ought to represent market expectations with respect to the future movement of the price of the underlying protected security. This volatility can be derived by solving for the volatility implied by exchange traded options on the underlying protected security for similar durations.

It is contemplated that an issuing entity providing or offering the financial product or instrument for protecting a security could hedge its risk in a number of ways. One way would be to purchase exchange traded options to offset the securities price change risk the entity was assuming. Since exchange traded options are American style options, which can be executed anytime prior to the exercise date, such options can be purchased to cover the general risks assumed through the sale of the financial instrument for protecting a security that, essentially, provide European style options. In addition, it is assumed that transaction costs for an entity purchasing options as a hedge against the issuance of the financial instrument for protecting a security would be significantly lower than the expenses built into the pricing for protecting a security. The difference between the built in implicit trading costs and the actual trading costs incurred under this approach would provide a source of profit of the entity issuing the financial product or instrument.

Another way to hedge would be to purchase options exactly equivalent to the options embedded in the instrument for protecting a security from a willing derivatives investor or by assigning the option pricing risk directly to a willing derivatives investor. Such an investor might even participate in pricing the net single charge designed to cover the product for protecting a security product's risk.

Another manner in which to hedge is to include or add risk margins to the risk charge, referred to herein as the net single charge with little impact on the product's competitive position. Such risk margins could significantly reduce the risk that the net single charge component of the gross charge would be inadequate to cover the investment risk being assumed by the issuing entity.

Other methods or approaches to hedging the risk are possible depending on the form of protection for a security that is offered. Examples of other methods may include self insurance, insurance, re-insurance, and capital reserves. The above examples are not meant to be exhaustive but illustrative.

The following is a calculation of a price to be charged for protecting a security with the security being a particular stock that is traded on a stock exchange. In this example the stock for General Electric Company, New York Stock Exchange symbol GE, will be used. In particular, such calculation for this security is based on values for this security on Apr. 21, 2005. Also, near-the-money exchange traded put options were used to calculate implied volatility for various terms to expiry. The Black-Scholes formula was used having the following input: the term to expiry was calculated in days to the option date and then converted to a fraction of a year; an exercise (strike) price nearest to the current stock price was selected; the risk free interest rate is 2.75%; and the exchange traded option price was used as a target in the spreadsheet program's goal seek function to solve for the volatility that would produce the market option price.

Table 1 illustrates the calculation of implicit volatility for GE stock.

TABLE 1

| BLACK- | | Today | | | | | |
|---|---|---|---|---|---|---|---|
| SCHOLES | Symbol | Apr. 21, 2005 | | | | | |
| Exercise | K | 35.00 | | | | | |
| Price | | | | | | | |
| Current | S | 35.80 | | | | | |
| Stock | | | | | | | |
| Price | | | | | | | |
| Expiry | | May 21, 2005 | Jun. 18, 2005 | Sep. 17, 2005 | Dec. 17, 2005 | Jan. 21, 2006 | Jan. 20, 2007 |
| Days | | 30 | 58 | 149 | 240 | 275 | 639 |
| Duration | t | 0.082192 | 0.158904 | 0.4082192 | 0.6575342 | 0.75342466 | 1.75068493 |
| (in years) | | | | | | | |
| Calculated | v | 0.17417 | 0.15973 | 0.18726 | 0.19315 | 0.20514 | 0.22312 |
| Implied | | | | | | | |
| Volatility | | | | | | | |
| Rounded | | 0.18 | 0.16 | 0.19 | 0.20 | 0.21 | 0.23 |
| Implied | | | | | | | |
| Volatility | | | | | | | |
| | d₁= | 0.52283 | 0.45540 | 0.34255 | 0.33805 | 0.33231 | 0.38724 |
| | d₂= | 0.47290 | 0.39173 | 0.22291 | 0.18143 | 0.15425 | 0.09203 |
| | Put= | 0.35 | 0.50 | 1.15 | 1.55 | 1.80 | 2.95 |

The calculated implied volatilities in this example have a skew by term to expiry. From the calculated implied volatility values, smoothed forecast volatilities for use in the pricing calculation may be chosen that closely match the curve by time to expiry. In practice, it is possible that a formulae approach that makes comparisons to historic volatilities may be devised. In addition, the inclusion of a small margin in the forecast volatilities might be used.

Table 2 illustrates the application of the assumed forecast volatilities, which can vary by term of coverage, in a Black-Scholes formula to calculate the net single charge for various protected amounts and terms of coverage. For example, the net single charge to be charged for protecting the GE stock at the stock's current value for a 90 day term of coverage would $1.23, rounded up from the value illustrated in Table 2. The net single charge covers the risk charge only. A load to cover expenses and profit would be added to the net single charge, as will be explained more fully herein. The net single charge to be charged for protecting the GE stock at 90% and 80% of the stock's current value are also shown in Table 2. It is possible and contemplated to calculate other net single charges for various other percentages of the stock's current or market value.

TABLE 2

| | Current | | | | 90% | 80% |
|---|---|---|---|---|---|---|
| Vola- | Share | Term of | | Protected | Protected | Protected |
| tility | Price | Coverage | Days | Price | Price | Price |
| v | S | t | | 35.80 | 32.22 | 28.64 |
| 0.17 | 35.8 | 0.0821918 | 30 | 0.65555 | 0.00789 | 0.00000 |
| 0.18 | | 0.1643836 | 60 | 0.96098 | 0.07151 | 0.00058 |
| 0.19 | | 0.2465753 | 90 | 1.22492 | 0.18325 | 0.00732 |
| 0.19 | | 0.4931507 | 180 | 1.66002 | 0.45867 | 0.06454 |
| 0.21 | | 1 | 365 | 2.49279 | 1.12141 | 0.37566 |
| 0.23 | | 2 | 730 | 3.60708 | 2.13470 | 1.09534 |
| 0.23 | | 3 | 1095 | 4.12531 | 2.65722 | 1.54043 |

For practical purposes, a reasonable level for expense loads would be set or modeled by the trading expenses an investor might otherwise incur if the investor were to use more traditional means to protect owned securities from a decline or a change in value. These traditional means may involve the purchase of exchange traded options and incurring the trading charges associated with such a purchase. For example, a put option could be purchased. Option trading costs vary somewhat depending upon which broker an investor uses and what type of account an investor has. Table 3 provides a range of charges for purchasing options from a number of leading brokers. The range of charges was compiled as of Apr. 21, 2005. All assume the use of Internet trading accounts with no broker assistance, except as noted.

TABLE 3

| Broker | Base Rate | Per Contract Charge |
|---|---|---|
| Ameritrade | $10.99 | $0.75 |
| Charles Schwab | | |
| More than 30 trades/Qtr | $9.95 | $0.95 |
| Less than 30 trades/Qtr | $9.95 | $1.40 |
| Automated Phone | $29.95 | $1.40 |
| Broker Assisted | $43.95 | $1.40 |
| E Trade | | |
| Trades/Month = 1,500+ | $6.99 | $0.75 |
| Trades/Month = 150-1,499 | $7.99 | $1.00 |
| Trades/Month = 15-149 | $9.99 | $1.25 |
| Less than 15 Trades/Month | $11.99 | $1.50 |
| & more than $50M+ in | | |
| Assets | | |
| Less than 15 Trades/Month | $14.99 | $1.75 |
| & less than $50M in Assets | | |
| T D Waterhouse | | |
| 30 + executed trades/Qtr | $9.95 | $1.25 |
| 9-29 executed trades/Qtr | $11.95 | $1.75 |
| Less than 9 executed | $17.95 | $1.75* |
| trades/Qtr | | |
| Automated Phone* | $35.00 | $1.75* |
| Broker Assisted* | $45.00 | $1.75* |

*A per contract charge of $1.25 applies for trades involving 50+ contracts.

Trading costs may also be reduced by brokerages for large accounts. For example, if the number of trades per month is larger than the number provided in Table 3 the brokerage may contract for lower fees or charges than listed in Table 3.

A “contract” is 100 options. Therefore, for example, a Charles Schwab customer who is purchasing 500 options with less than 50 trades per month would incur trading charges equal to $16.95 calculated as:
$9.95+(5 contracts×$1.40 per contract)=$16.95.

The E Trade customer would expect to pay $23.74, assuming less than 15 trades per month and a small account. The T D Waterhouse customer for the same trade and assuming less than 9 trades would be charged $26.70.

In view of these possible charges that an investor could expect to pay, it can be assumed that a reasonable per financial instrument load of $12.00 plus a per share protected load of $0.02 could be used as a reasonable trading charge level. As will be discussed further herein, it is also possible and contemplated that other charges could be assumed or used. For example, higher or lower levels could be applied in actual practice based on the market conditions and the competitive environment.

Another monetary component or charge to consider is the cost to exercise a put option. If the underlying security declined in value during the put option term then this would require the sale of the underlying security for which trading charges would be incurred. Alternatively, the sale of the put option would incur trading charges. Table 4 illustrates brokerage commissions for stock trading for the same set of brokerages shown in Table 3. All of the following charges apply to on line Internet trading.

TABLE 4

| | Flat Rate for Stock Trade* |
|---|---|
| Broker | |
| Ameritrade | $10.99 |
| Charles Schwab | |
| More than 30 trades/Qtr | $9.95 |
| 9-29 trades/Qtr | $12.95 |
| Less than 8 trades/Qtr | $19.95 |

*Plus $0.015 for each share traded in excess of 1,000

| | |
|---|---|
| E Trade | |
| Trades/Month = 1,500+ | $6.99 |
| Trades/Month = 150-1,499 | $7.99 |
| Trades/Month = 15-149 | $9.99 |
| Less than 15 Trades/Month & | $11.99 |
| more than $50M+ in | |
| Assets | |
| Less than 15 Trades/Month & | $14.99 |
| less than $50M+ in | |
| Assets | |

*Plus $0.015 for each share traded in excess of 2,000

| | |
|---|---|
| T D Waterhouse | |
| 30+ executed trades | $9.95 |
| 9-29 executed trades | $11.95 |
| Less than 9 executed trades | $17.95 |

*Plus $0.01 for each share traded in excess of 2,500 shares

Stock trading charges are similar to the base rate for an option trade. A per share trading cost may apply, as noted above, for trades of a high number of shares.

While an investor could exercise the put option and sell the underlying stock, by selling an in-the-money put option just prior to the exercise date, an investor can realize the value of the put option and retain ownership of the underlying security. Therefore, this component of the expense loading can be estimated as a charge identical to the first component charge.

The use of an exchange traded option to hedge against a decline in an underlying stock's value would result in two sets of trading charges or commissions which can be used as a basis for determining an acceptable load for expense and profit to be applied in the calculation of a gross single charge. Table 5, therefore, illustrates reasonable loads for expense and profit that may be used to derive a gross single charge for protecting a security on a per share basis.

TABLE 5

| | Per Financial | |
|---|---|---|
| Component | Instrument Load | Per Share Protected |
| Purchase Option Trading | $12.00 | $0.02 |
| Charge Component | | |
| Sale Option Trading Charge | $12.00 | $0.02 |
| Component | | |
| TOTAL | $24.00 | $0.04 |

The per financial product load or charge in Table 5 could be converted to a per share protected charge by dividing by the number of shares protected. For example, if 500 shares were protected the per share charge would be calculated as:
24.00/500+0.04=0.088

It is also possible that additional amounts may be added to this per share charge for an issuing entity to derive additional profit. For example, due to the economic environment, it may be possible for the entity to round up to $0.09 or even $0.10. Further, after analyzing other factors, the issuing entity may be able to realize more profit by adding to the per share charge based upon a competitive advantage or size. Also, the profit portion of the expense and profit load may be a percentage of the calculated per share charge. For example, if a 10% profit margin is desired then 10% of $0.088 may be added to the per share charge or $0.0088 would be added to the per share charge for a total of $0.0968. The calculation of the expense and profit load may be separately calculated. For example, the expense load may be determined and then the issuing entity may determine that a profit of 10% may be added to the determined expense load. The issuing entity may also consider a range for the profit load. Also, the amount of $0.0968 is used as an example of how the load for expense and profit is determined. This amount includes both the expense and profit load or it may only represent the expense load and a profit load may be added as previously explained.

From the above example, the gross single charge that an investor who purchased the financial product for protecting a security would be charged can be derived or determined by adding loads for expense and profit to the calculated net single charge. The net single charge represents the risk cost. For example, the gross single charge for protecting a security per share of GE stock for a 90 day term of coverage would be calculated as follows:

| | |
|---|---|
| Net single charge | $1.23 |
| Load for expense and profit | $0.0968 |
| TOTAL Gross Charge | $1.3268 per share |

On Apr. 21, 2005, when this total gross charge was calculated, GE was trading for $35.80 per share. The gross single charge paid by the investor would be $1.3268 per share or this amount could be rounded up to be $1.33 per share. For purposes of example only, if 500 shares of GE stock were to be protected, then the gross single charge for a 90 day term of would be $665 (the per share premium of $1.33 times 500 shares). Of the total gross charge, $48.40 would be attributable to expenses and profit for the issuing company or entity ($0.0968 times 500 shares).

The above discussion was related to how to determine or calculate a risk charge when the underlying security to be protected was stock. When the underlying security to be protected is another type of security such as a bond or a mutual fund then the risk charge can be determined or calculated as follows. If an option does not exist for the security to be protected then the entity issuing the financial product could enter into an options contract with a willing derivatives investor such as a brokerage house or an investment bank. Another method would be to purchase electronic traded fund (ETF) options that track or mimic a bond index or a mutual fund. The issuing entity could also add risk margins to the risk charge. Another method would be to construct an artificial option, that is, a theoretical option for the security being protected, using historical and projected data to estimate volatility. Other methods to determine the risk charge for different types of securities may include self-insurance, insurance, re-insurance, and capital reserves.

FIG. 11 depicts a flow chart diagram of a method 270 for calculating or determining a price to be charged for a financial instrument for protecting a portfolio of securities. In a first step 272, a risk charge or a net single charge for a portfolio is determined. The risk charge may be based on such factors as the protected amount, the term of coverage, and the current prices of the securities to be protected. Once the risk charge is determined an expense and profit load is then determined in a step 274. In a next step 276, the risk charge and the expense and profit load are added together to arrive at a total gross charge or price to be offered or charged. The total gross charge or price is the amount an investor will pay to protect a portfolio of securities.

In order to determine a price for protecting a portfolio of securities the following methodology may be employed. One option would be to protect the entire portfolio with one financial instrument so that if the value of the entire portfolio declined below the protected amount then a benefit or an amount would be paid to the investor. This requires that volatility for the entire portfolio be calculated and applied to determine a net single charge to which an expense and profit load would be added to determine the gross charge to be charged to the investor. For this example, a portfolio consisting of four securities will be used. The four securities are GE stock, SPY, NASDAQ, and IBM stock. As previously indicated, GE is a stock traded on the New York Stock Exchange. SPY is the symbol for Standard & Poors Depositary Receipts that is an exchange traded fund (EFT) designed to track specific market indexes. NASDAQ stands for NASDAQ 100 Index Tracking Stock that is an exchange traded fund designed to track specific market indexes. The actual symbol for this security is QQQQ, but NASDAQ will be used as the symbol for the examples herein. This security, QQQQ, is traded on NASDAQ. Also, IBM is the symbol for IBM stock traded on the New York Stock Exchange. Further, the four securities are distributed within a portfolio having the following percentages: 30% GE, 30% SPY, 30% NASDAQ, and 10% IBM. The following table, Table 6, lists these securities and the closing prices or quotes for the securities over a twenty-one day period from Mar. 23, 2005, until Apr. 21, 2005.

TABLE 6

| | | Closing Quotes | | | | Weighted |
|---|---|---|---|---|---|---|
| | | Weights | | | | Average |
| | | 0.3 | 0.3 | 0.3 | 0.1 | Share |
| X | Date | GE | SPY | NASDAQ | IBM | Price |
| 21 | Apr. 21, 2005 | 36.12 | 116.01 | 35.62 | 74.03 | 63.73 |
| 20 | Apr. 20, 2005 | 35.52 | 113.80 | 34.70 | 72.01 | 62.41 |
| 19 | Apr. 19, 2005 | 36.00 | 115.41 | 34.99 | 75.48 | 63.47 |
| 18 | Apr. 18, 2005 | 36.00 | 114.50 | 34.75 | 76.65 | 63.24 |
| 17 | Apr. 15, 2005 | 35.75 | 114.15 | 34.74 | 76.70 | 63.06 |
| 16 | Apr. 14, 2005 | 35.50 | 115.77 | 35.55 | 83.64 | 64.41 |
| 15 | Apr. 13, 2005 | 35.64 | 117.30 | 36.06 | 84.57 | 65.16 |
| 14 | Apr. 12, 2005 | 36.09 | 118.70 | 36.66 | 85.75 | 66.01 |
| 13 | Apr. 11, 2005 | 35.82 | 118.09 | 36.48 | 86.20 | 65.74 |
| 12 | Apr. 08, 2005 | 35.74 | 118.00 | 36.64 | 87.60 | 65.87 |
| 11 | Apr. 07, 2005 | 35.78 | 119.24 | 36.94 | 88.44 | 66.43 |
| 10 | Apr. 06, 2005 | 35.50 | 118.60 | 36.50 | 89.00 | 66.08 |
| 9 | Apr. 05, 2005 | 35.50 | 118.19 | 36.56 | 89.57 | 66.03 |
| 8 | Apr. 04, 2005 | 35.24 | 117.63 | 36.46 | 90.32 | 65.83 |
| 7 | Apr. 01, 2005 | 35.47 | 117.43 | 36.20 | 90.44 | 65.77 |
| 6 | Mar. 31, 2005 | 36.06 | 117.96 | 36.57 | 91.38 | 66.32 |
| 5 | Mar. 30, 2005 | 36.20 | 118.18 | 36.73 | 90.68 | 66.40 |
| 4 | Mar. 29, 2005 | 35.53 | 116.53 | 36.05 | 90.60 | 65.49 |
| 3 | Mar. 28, 2005 | 35.97 | 117.31 | 36.34 | 91.04 | 65.99 |
| 2 | Mar. 24, 2005 | 35.73 | 117.14 | 36.27 | 90.70 | 65.81 |
| 1 | Mar. 23, 2005 | 35.50 | 117.00 | 36.26 | 90.52 | 65.68 |

The volatility for these securities may be collected from any available source. Closing stock quotes for Apr. 21, 2005, were used to derive historical volatility measured over the twenty-one day period. The standard formula used for calculating volatility is as follows:

$$σ = \sqrt{\frac{{\sum }_{t = 1}^{N} {( {x}_{t} - μ )}^{2}}{N - 1}}$$

where x=1n(Sₜ)/1n(Sₜ₋₁) when Sₜ is the stock quote for period t and μ is the mean of the value x.

The calculated historical volatility, as shown in Table 7, is 15.9%. Note that historical volatilities for each security were also calculated and that these volatilities are different from the implied volatilities derived from market prices for current options available on these securities that are somewhat higher except for IBM. For this portfolio pricing example the volatility was set at the historical level, 15.9%, although a method giving value to the market effect on volatility as observed for the individual securities might be applied to add margin.

TABLE 7

| | | | | | Weighted |
|---|---|---|---|---|---|
| | | | | | Average |
| | GE | SPY | NASDAQ | IBM | Share Price |
| | 0.01675 | 0.01923 | 0.02617 | 0.02767 | 0.02095 |
| | −0.01342 | −0.01405 | −0.00832 | −0.04706 | −0.01686 |
| | 0.00000 | 0.00792 | 0.00688 | −0.01538 | 0.00360 |
| | 0.00697 | 0.00306 | 0.00029 | −0.00065 | 0.00282 |
| | 0.00702 | −0.01409 | −0.02305 | −0.08662 | −0.02115 |
| | −0.00394 | −0.01313 | −0.01424 | −0.01106 | −0.01153 |
| | −0.01255 | −0.01186 | −0.01650 | −0.01386 | −0.01301 |
| | 0.00751 | 0.00515 | 0.00492 | −0.00523 | 0.00414 |
| | 0.00224 | 0.00076 | −0.00438 | −0.01611 | −0.00208 |
| | −0.00112 | −0.01045 | −0.00815 | −0.00954 | −0.00844 |
| | 0.00786 | 0.00538 | 0.01198 | −0.00631 | 0.00531 |
| | 0.00000 | 0.00346 | −0.00164 | −0.00638 | 0.00073 |
| | 0.00735 | 0.00475 | 0.00274 | −0.00834 | 0.00305 |
| | −0.00651 | 0.00170 | 0.00716 | −0.00133 | 0.00087 |
| | −0.01650 | −0.00450 | −0.01017 | −0.01034 | −0.00819 |
| | −0.00387 | −0.00186 | −0.00437 | 0.00769 | −0.00130 |
| | 0.01868 | 0.01406 | 0.01869 | 0.00088 | 0.01377 |
| | −0.01231 | −0.00667 | −0.00801 | −0.00484 | −0.00756 |
| | 0.00669 | 0.00145 | 0.00193 | 0.00374 | 0.00270 |
| | 0.00646 | 0.00120 | 0.00028 | 0.00199 | 0.00201 |
| Variance per | 9.5337E−05 | 8.5250E−05 | 1.3929E−04 | 5.1320E−04 | 1.0032E−04 |
| Day | | | | | |
| Trading Days | 252 | 252 | 252 | 252 | 252 |
| in Year | | | | | |
| Annual | 0.0240250 | 0.0214830 | 0.0351021 | 0.1293255 | 0.0252812 |
| Variance | | | | | |
| Annual | 15.5% | 14.7% | 18.7% | 36.0% | 15.9% |
| Volatility | | | | | |

The net single charges on the entire portfolio are shown in the following Table 8. For example, for a financial instrument that would protect against a portfolio decreasing in value from a protected price of $63.73 per share, the net single charge for a 90 day term of coverage is $1.79 per share. The net single charge represents the risk cost. The net single charge to be charged for protecting the portfolio at 90% and 80% of the current value of the portfolio are also shown in Table 2. It is possible and contemplated to calculate other net single charges for various other percentages of the portfolio's current or market value.

TABLE 8

| | Current | | | Pro- | 90% | 80% |
|---|---|---|---|---|---|---|
| | Share | Term of | | tected | Protected | Protected |
| Volatility | Price | Coverage | | Amount | Amount | Amount |
| v | S | t | Days | 63.73 | 57.36 | 50.98 |
| 0.159 | 63.73 | 0.082192 | 30 | 1.08702 | 0.00845 | 0.00000 |
| 0.159 | | 0.164384 | 60 | 1.49532 | 0.07045 | 0.00019 |
| 0.159 | | 0.246575 | 90 | 1.79209 | 0.16693 | 0.00232 |
| 0.159 | | 0.493151 | 180 | 2.40977 | 0.49275 | 0.03857 |
| 0.159 | | 1 | 365 | 3.17844 | 1.06863 | 0.21886 |
| 0.159 | | 2 | 730 | 4.01157 | 1.84215 | 0.64490 |
| 0.159 | | 3 | 1095 | 4.47653 | 2.34102 | 1.00683 |

The expense and profit load can be derived or calculated in the same manner as described and shown with respect to Table 5. In this particular example, the expense and profit load will be $0.088 per share.

The gross charge that an investor who purchased a financial instrument to protect a portfolio of securities would be charged can be derived or calculated by adding the loads for expense and profit to the calculated net single charge. Table 9 illustrates the results of the calculations for gross charges.

TABLE 9

| | |
|---|---|
| Term of Coverage | Protected Amount |

| t | Days | 63.73 |
|---|---|---|
| 0.082192 | 30 | 1.18 |
| 0.164384 | 60 | 1.58 |
| 0.246575 | 90 | 1.88 |
| 0.493151 | 180 | 2.50 |
| 1 | 365 | 3.27 |
| 2 | 730 | 4.10 |
| 3 | 1095 | 4.56 |

Referencing Table 9 it can be seen that for protecting a portfolio the gross single charge calculation is done per average portfolio share. For a financial instrument that will protect 100% of the average share's current value for a 90 day term of coverage the gross single charge is calculated as follows:

| | |
|---|---|
| Net single charge | $1.79 |
| Load for expense and profit | $0.088 |
| TOTAL Gross charge | $1.88 (rounded) |

It is important to note that there may or may not be a pricing advantage in protecting the portfolio as a whole depending on how the share prices in the portfolio change relative to each other. This is, if the share prices in a portfolio tend to move in opposite directions, then protecting the portfolio as a whole may be cheaper since the rise of one security would tend to offset the fall in another which would have a moderating effect on the volatility of the portfolio.

It is also possible that an investor may only protect specific securities within a portfolio, or protect each security in the portfolio with a separate financial instrument each of which would pay a benefit related only to the market value fluctuation of the specifically protected security, or as outlined above, an investor would protect the entire portfolio with one financial instrument so that only if the value of the entire portfolio declined below the protected amount would a benefit be paid.

As has been previously discussed, other options pricing formulas or algorithms to determine a risk charge such as Binomial Pricing, Flexible Binomial Pricing, Finite Difference, and Analytic Approximation may be employed. Further, taxes may be included in the computation for the expense load. It is also possible that the expense load and the profit load may be calculated separately.

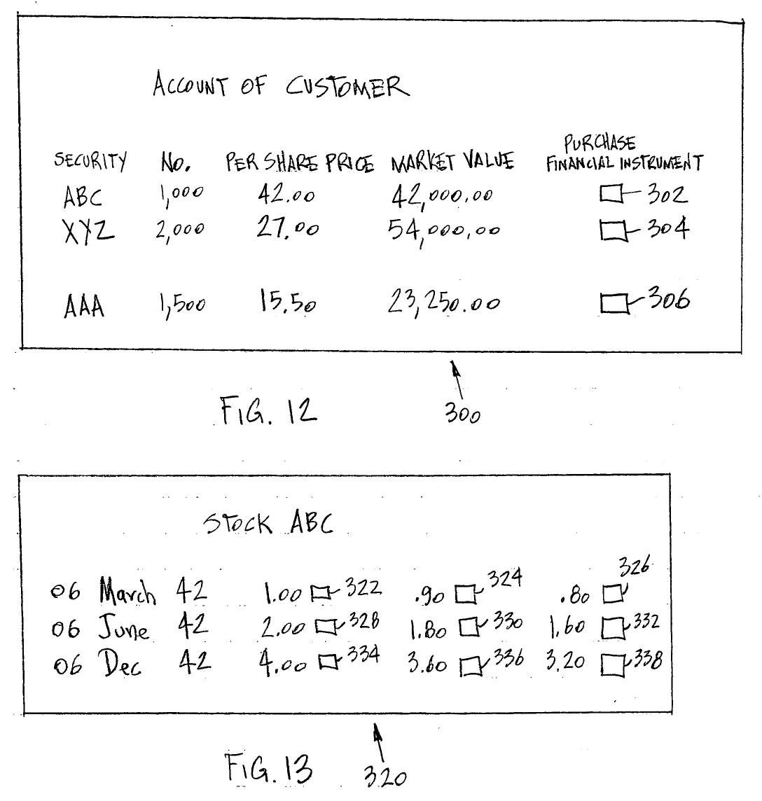

With reference now to FIG. 12, a screen 300 is illustrated which shows a brokerage account of a customer that may be used to purchase a financial instrument. In particular the screen 300 depicts the account or a portfolio of a customer at a brokerage or other investment entity. The customer owns 1,000 shares of ABC stock, 2,000 shares of XYZ stock, and 1,500 shares of AAA mutual fund. Other information, such as per share price and the market value of each security, may be shown on the screen 300. Next to each security is a box 302, 304, or 306 which may be selected by the customer to purchase a financial instrument to protect the customer from a decrease in the market value of the security. As can be appreciated and as has been indicated previously, if the security is being shorted then the customer can purchase the financial instrument to protect against an increase in the market value of the shorted security.

Once one of the boxes 302, 304, or 306 is selected, for example the box 302, a new screen 320, as is shown in FIG. 13, may be presented to the customer. The screen 320 is used for the customer to select which financial instrument should be purchased to protect the customer's position in the particular security. In this example the stock of ABC Company was selected. The screen 320 shows various options that are available for the customer to select. If the customer wants to protect the stock for a period of 90 days then a box 322 may be selected. If the customer only wants to protect a percentage of the security, for example, 90%, then a box 324 may be selected. Further, the option of protecting 80% of the security is available by selecting a box 326. Once one of the boxes 322, 324, or 326 is selected another screen (not shown) may be presented to the customer for the customer to select a payment method. For example, if the customer has a money market account with the brokerage then the cost for the financial instrument may be deducted directly from the money market account. Other methods of payment are possible and contemplated such as credit card, check, or sale of securities.

If the customer wants to protect the security for a longer term, for example 180 days, then a box 328 may be selected. If a lesser amount of coverage is needed, for example 90% for 180 days, then a box 330 may be selected. Also, if an even lesser amount of coverage is needed, for example 80% for 180 days, then a box 332 may be selected. Boxes 334, 336, and 338 may be selected if a term of 365 days is desired and various percentages of coverage are wanted, such as 100%, 90%, and 80%, respectively. It is further contemplated and possible that a customized price may be calculated as has been previously discussed or a box (not shown) may be provided for calculating various pricing options for protecting the customer's portfolio or account at a brokerage.

Although the present system and method have been described by use of electronic devices and means, it is also possible that an agent, a broker, or other salesperson may provide the price information to a user. For example, an agent may discuss the various securities to be protected and provide a quote for a financial instrument to a user. The user may review the quote and then determine whether to protect the security or securities. In this manner, the user does not directly interact with the electronic system and relies on the agent for information and the price quote. Also, the agent or the system may already have predetermined prices for any type security, for any amount of coverage, and for any length or term. The user may select the price to be paid for coverage from a listing or a table of the predetermined prices much like is illustrated in table 50. It is also possible that a user may contact a banker, broker, or other type agent that handles the financial product in person or by telephone to transact a purchase of the financial product, contract, or instrument.

From all that has been said, it will be clear that there has thus been shown and described herein a system and method for protecting a security which fulfills the various objects and advantages sought therefore. It will become apparent to those skilled in the art, however, that many changes, modifications, variations, and other uses and applications of the subject system and method for protecting a security are possible and contemplated. All changes, modifications, variations, and other uses and applications which do not depart from the spirit and scope of the invention are deemed to be covered by the invention, which is limited only by the claims which follow.

What is claimed is:

1. A method for protecting a security comprising the steps of:
obtaining a security; and
purchasing a financial instrument for protecting against a change in the value of the security.

2. The method of claim 1 wherein the step of purchasing a financial instrument comprises the step of determining a price to be charged for the financial instrument.

3. The method of claim 1 wherein the step of purchasing a financial instrument comprises the step of determining a term of the financial instrument.

4. The method of claim 1 wherein the step of purchasing a financial instrument comprises the step of determining an amount of coverage.

5. The method of claim 4 wherein the amount of coverage is equal to the value of the security.

6. The method of claim 1 further comprising the steps of obtaining a second security and purchasing a second financial instrument for protecting against a change in value of the second security.

7. A system for protecting a security comprising:
a server system adapted for receiving entered information related to a security from a computer system, for calculating a price for a financial instrument for protecting a security, and the server system for transmitting the price to a computer system.

8. The system of claim 7 wherein the server system is capable of receiving information related to a term for the financial instrument.

9. The system of claim 7 wherein the server system is capable of receiving information related to an amount of coverage.

10. The system of claim 7 wherein the server system is capable of receiving information related to protecting a second security.

11. The system of claim 7 wherein the server system is capable of recalculating a price for a financial instrument based upon revised information received from a computer system.

12. A method for protecting a security comprising the steps of:
obtaining an interest in a security; and
purchasing a financial product for protecting against-a change in value of the security.

13. The method of claim 12 wherein the step of purchasing a financial product comprises the step of determining a price to be paid for purchasing the financial product.

14. A method for protecting a portfolio of securities comprising the steps of:
obtaining a portfolio of securities; and
purchasing a financial instrument for protecting against a change in value of the portfolio.

15. The method of claim 14 wherein the step of purchasing a financial instrument comprises the step of determining a price to be charged for purchasing the financial instrument.

16. The method of claim 14 wherein the step of purchasing a financial instrument comprises the step of determining a term for the financial instrument.

17. The method of claim 14 wherein the step of purchasing a financial instrument comprises the step of determining a price to be charged for purchasing the financial instrument for protecting against a change in value of a portion of the securities in the portfolio.

18. A method of protecting a portion of a portfolio of securities comprising the steps of:
obtaining a portfolio of securities; and
purchasing a financial product for protecting against a change in value of a portion of the portfolio.

19. The method of claim 18 wherein the step of purchasing a financial product comprises the step of determining a price to be charged for purchasing the financial product.

20. A system for protecting a portfolio of securities comprising:
a server system adapted for receiving entered information from a computer system related to a portfolio of securities, for calculating a price for a financial product for protecting the portfolio of securities, and the server system for transmitting the price to a computer system.

21. The system of claim 20 wherein the server system is capable of receiving information related to a term for the financial product.

22. The system of claim 20 wherein the server system is capable of receiving information related to an amount of coverage for the financial product.

23. The system of claim 20 wherein the server system is capable of receiving information related to a number of securities in the portfolio.

24. The system of claim 20 wherein the server system is capable of recalculating a price for the financial product based upon revised information received from a computer system.

25. A method for protecting a portfolio of securities comprising the steps of:
obtaining an interest in a portfolio of securities; and
purchasing a financial instrument for protecting against a change in value of the portfolio of securities.

26. The method of claim 25 wherein the step of purchasing a financial instrument comprises the step of determining a price to be charged for purchasing the financial instrument.

27. The method of claim 25 wherein the step of purchasing a financial instrument comprises the step determining a term for the financial instrument.

28. The method of claim 25 wherein the step of purchasing a financial instrument comprises the step of determining an amount of coverage.

29. A method for protecting a portion of a portfolio of securities comprising the steps of:
obtaining an interest in a portfolio of securities; and
purchasing a financial product for protecting against a change in value of a portion of the portfolio.

30. The method of claim 29 wherein the step of purchasing a financial product comprises the step of determining a price to be paid for the financial product.

31. A system for protecting a portion of a portfolio of securities comprising:
a server system adapted for receiving entered information from a computer system related to a portfolio of securities, for calculating a price for a financial instrument for protecting a portion of a portfolio of securities, and the server system for transmitting the price to a computer system.

32. The system of claim 31 wherein the server system is capable of receiving information related to a term for the financial instrument.

33. The system of claim 31 wherein the server system is capable of receiving information related to an amount of coverage for the financial instrument.

34. The system of claim 31 wherein the server system is capable of recalculating the price based upon revised information received from a computer system.

35. A method for determining a price for a financial instrument for protecting a security comprising the steps of:
determining a risk charge based upon a security to be protected;
determining an expense and profit load; and
combining the risk charge and the expense and profit load to determine a total gross charge.

36. The method of claim 35 wherein the step of determining a risk charge comprises the step of determining an expense associated with trading an option to protect the security.

37. The method of claim 35 wherein the step of determining a risk charge comprises the step of determining a solution to a Black-Scholes pricing formula.

38. The method of claim 35 wherein the step of determining an expense and profit load comprises the step of determining an expense associated with buying and selling an option.

39. The method of claim 38 wherein the step of determining an expense and profit load further comprises the step of determining a profit.

40. The method of claim 38 wherein the step of determining an expense and profit load comprises the step of taking a percentage of the expense.

41. The method of claim 35 wherein the step of determining a risk charge comprises the step of determining a current price of the security to be protected and determining a volatility of the security to be protected.

42. A system for determining a price for protecting a security comprising a computer system capable of having entered information related to a security to be protected, the computer system having a program for calculating a risk charge based upon the security to be protected, for calculating an expense and profit load, and for combining the risk charge and the expense and profit load to determine a total gross charge.

43. The system of claim 42 wherein the computer system is capable of determining a current price of the security to be protected and for determining a volatility of the security to be protected.

44. The system of claim 42 wherein the computer system is capable of calculating the risk charge based on an expense associated with trading an option to protect the security.

45. The system of claim 42 wherein the computer system is capable of calculating the risk charge based on a solution to a Black-Scholes pricing formula.

46. The system of claim 42 wherein the computer system is capable of calculating the expense and profit load based on an expense associated with buying and selling an option.

47. The system of claim 46 wherein the computer system is capable of calculating the expense and profit load based on taking a percentage of the expense associated with buying and selling an option.

48. The system of claim 42 wherein the computer system is capable of calculating the risk charge based on a current price of the security to be protected and a volatility of the security to be protected.

49. A method for determining a price for protecting a portfolio of securities comprising the steps of:
determining a risk charge for the portfolio of securities;
determining an expense and profit load for the portfolio of securities; and
combining the risk charge and the expense and profit load to determine a total gross charge for protecting the portfolio of securities.

50. The method of claim 49 wherein the step of determining the risk charge for the portfolio of securities comprises the step of determining an expense associated with trading options to protect each of the securities in the portfolio.

51. The method of claim 49 wherein the step of determining the risk charge comprises the step of determining a solution to a Black-Scholes pricing formula.

52. The method of claim 49 wherein the step of determining an expense and profit load comprises the step of determining a profit.

53. The method of claim 49 wherein the step of determining a risk charge for a portfolio of securities comprises the steps of determining a current price of each security in the portfolio to be protected and determining a volatility of each security in the portfolio to be protected.

54. A system for determining a price for protecting a portfolio of securities comprising a computer system capable of having entered information related to a portfolio of securities to be protected, the computer system having a program for calculating a risk charge for the portfolio of securities, for calculating an expense and profit load for the portfolio of securities, and for combining the risk charge and the expense and profit load to determine a total gross charge for the portfolio of securities.

55. The system of claim 54 wherein the computer system is capable of determining a current price for each of the securities to be protected and for determining volatility for each of the securities to be protected.

56. The system of claim 54 wherein the computer system is capable of calculating the risk charge based on an expense associated with trading an option to protect each of the securities in the portfolio.

57. The system of claim 54 wherein the computer system is capable of calculating the risk charge based on a current price of each of the securities in the portfolio and volatility of each of the securities in the portfolio.

58. A method for determining a price for a financial instrument for protecting a security comprising the steps of:
determining a risk charge based upon a security to be protected;
determining an expense load;
determining a profit load; and
combining the risk charge, the expense load, and the profit load to determine a total gross charge.

59. A method for purchasing a financial product over a computer network for protecting a security comprising the steps of:
accessing a web site for purchasing a financial product for protecting a security;
entering information relating to a security to be protected;
reviewing information relating to a price to be paid for purchasing the financial product; and
paying the price for the financial product.

60. The method of claim 59 wherein the step of entering information comprises the step of entering the name of the security to be protected.

61. The method of claim 59 wherein the step of entering information comprises the step of entering a value for the security to be protected.

62. The method of claim 59 wherein the step of entering information comprises the step of entering an amount of coverage.

63. The method of claim 59 further comprises the step of calculating a price for the financial product.

64. The method of claim 59 wherein the step of reviewing information comprises the step of determining whether the price should be accepted, rejected, or recalculated.

65. The method of claim 59 further comprising the steps of entering information relating to a second security to be protected, reviewing information relating to a second price to be paid for purchasing the financial product, and paying the second price.

66. A system for purchasing a financial instrument for protecting a security comprising a computer system capable of being assessed over an Internet, the computer system capable of providing various screens and for receiving entered information relating to a security to be protected, determining a price to be paid for the financial instrument, and for receiving entered information relating to a payment for the financial instrument.

67. The system of claim 66 wherein the computer system is further capable of receiving entered information relating to a term for the financial instrument.

68. The system of claim 66 wherein the computer system is further capable of receiving entered information relating to an amount of coverage for the financial instrument.

69. The system of claim 66 wherein the computer system is further capable of receiving entered information related to protecting a second security.

70. The system of claim 66 wherein the computer system is further capable of recalculating the price based upon revised information entered in the computer system.

71. A method for purchasing a financial product for protecting a portfolio of securities over a computer network comprising the steps of:
accessing a web site for purchasing a financial product for protecting a portfolio of securities;
entering information relating to the portfolio of securities to be protected;
reviewing information relating to a price to be paid for purchasing the financial product; and
paying the price for the financial product.

72. The method of claim 71 wherein the step of entering information comprises the step of entering the names of the securities to be protected.

73. The method of claim 71 wherein the step of entering information comprises the step of calculating the price to be paid.

74. The method of claim 71 wherein the step of reviewing information comprises the step of determining whether the price should be accepted, rejected, or recalculated.

75. The method of claim 71 wherein the step of paying the price for the financial product comprises the step of entering information relating to a payment method.

76. A method for providing a financial product for protecting a security over a computer network comprising the steps of:
providing a web site for purchasing a financial product for protecting a security;
receiving information relating to a security to be protected; and
determining a price to be charged for providing the financial product.

77. The method of claim 76 further comprising the step of receiving payment of the price for the financial product.

78. The method of claim 76 wherein the step of receiving information comprises the step of receiving a value of the security to be protected.

79. The method of claim 76 wherein the step of receiving information comprises the step of receiving an amount of coverage.

80. The method of claim 76 further comprising the steps of receiving information relating to a second security to be protected and determining a second price to be charged for providing the financial product.

81. A method for providing a financial instrument for a portfolio of securities over a computer network comprising the steps of:
providing a web site for purchasing a financial instrument for protecting a portfolio of securities;
receiving information relating to a portfolio of securities to be protected;
determining a price to be charged for providing the financial instrument for protecting a portfolio of securities; and
receiving payment for the financial instrument.

82. The method of claim 81 wherein the step of receiving information comprises the step of receiving a name of each of the securities within the portfolio to be protected.

83. The method of claim 81 wherein the step of receiving information comprises the step of receiving a value for each of the securities within the portfolio to be protected.

84. The method of claim 81 wherein the step of receiving information comprises the step of receiving an amount of coverage for each of the securities within the portfolio to be protected.

85. A method for purchasing a financial instrument for protecting a portion of a portfolio of securities over a computer network comprising the steps of:
accessing a web site for purchasing a financial instrument for protecting a portion of a portfolio of securities;
entering information relating to the portfolio of securities to be protected;
reviewing information relating to a price to be paid to purchase the financial instrument for protecting a portion of the portfolio of securities; and
paying the price.

86. The method of claim 85 wherein the step of entering information comprises the step of entering the names of the securities in the portfolio to be protected.

87. The method of claim 85 wherein the step of entering information comprises the step of entering the names of which of the securities in the portfolio that are to be protected.

88. The method of claim 85 wherein the step of reviewing information comprises the step of determining whether the price should be accepted, rejected, or recalculated.

89. A system for purchasing a financial product for protecting a portfolio of securities comprising a computer system capable of being accessed over an Internet, the computer system capable of providing various screens and for receiving entered information relating to a portfolio of securities to be protected, determining a price to be charged for a financial product for protecting the portfolio of securities, and for receiving entered information relating to payment for the price.

90. A system for purchasing a financial product for protecting a portion of a portfolio of securities comprising a computer system capable of being accessed over an Internet, the computer system capable of providing various screens and for receiving entered information relating to a portion of a portfolio of securities to be protected, determining a price to be charged for a financial product for protecting the portion of the portfolio of securities, and for receiving entered information relating to payment for the price.

91. A method for protecting a portfolio of securities comprising the steps of:
obtaining a portfolio of securities; and
purchasing a financial instrument for protecting against a change in value of any of the securities within the portfolio of securities.

92. A method for protecting a portfolio of securities comprising the steps of:
obtaining a portfolio of securities; and
purchasing a financial instrument for each of the securities within the portfolio for protecting against a change in value of any of the securities within the portfolio of securities.
